(19) United States
(12) Patent Application Publication
(10) Pub. No.: US 2011/0228714 A1
(43) Pub. Date: Sep. 22, 2011

(54) METHOD AND SYSTEM FOR RETRANSMISSION IN ASM

(76) Inventors: Balash AKBARI, Vancouver (CA); Varadhan VENKATASESHAN, Richmond (CA)

(21) Appl. No.: 13/039,231

(22) Filed: Mar. 2, 2011

Related U.S. Application Data
(60) Provisional application No. 61/309,762, filed on Mar. 2, 2010.

(51) Int. Cl. H04W 4/00

(52) U.S. Cl. 370/310

(57) ABSTRACT

Systems and methods for retransmitting a missing data packet. When at least two reports of the missing data packet are received, then the packet is retransmitted. When a subsequent request for the same data packet is received, then the time difference between the subsequent request and the retransmission is obtained and compared to a predefined retransmission timeout. If the time difference is greater, the packet is again retransmitted.

### CLAIM OF PRIORITY

This application claims the benefit of U.S. Provisional Patent App. No. 61/309,762 entitled RETRANSMISSION IN ASM, by Balash Akbari et al., filed Mar. 2, 2010, the entire contents of which are incorporated herein by reference.

### TECHNICAL FIELD

The present invention relates to the field of packet-based networks.

### BACKGROUND

A significant number of packet protocols have been developed and optimized specifically for wired networks. For example, the congestion control used in the Transmission Control Protocol (TCP) has been adapted over time to achieve maximum throughput in fixed bandwidth networks, and to work in a “fair” manner even during heavy network congestion. However, with the move to packet based networks over a wireless infrastructure, these congestion mechanisms are not well suited to the different characteristics found in such a wireless domain, such as:

1. A Longer Latency/Round Trip Time.

The lower bandwidth of the wireless network introduces a considerable amount of latency for a packet. The longer latency is also caused by the nature of the shared network, in which each session waits for the appropriate scheduling to enter the network.

2. Variable Bandwidth.

The bandwidth to a given mobile or wireless device is a function of many factors. For example, as the user moves, the distance to the antennae moves, which may result in obstructions. Even if the user is stationary there are factors that can impact bandwidth, including vehicles moving between the user and the antennae, other users on the network entering and leaving the shared medium, proximity to other networks, and the associated power/bandwidth management of the radio frequency (RF) signals.

The longer latency and longer round trip time impacts TCP's ability to quickly ascertain the available bandwidth in a static bandwidth environment. In an environment with a high variable bandwidth, the problem is exacerbated for TCP to efficiently track the available bandwidth.

Variable bandwidth can also indirectly lead to packet drop, which is a significant concern for a wireless network operator. In a situation in which two or more TCP sessions are made aware of available bandwidth in the wireless network, they will increase their data flow speed. This can result in an overloading of the buffers inside the network. Consequently, packets can be dropped off of the tail of the buffer. When there is an excess of packets and some are dropped, retransmission occurs, consuming resources that would otherwise be used to transport new packets.

There are often multiple, simultaneous TCP sessions from multiple sources all destined for a single endpoint. An example would be a user surfing the Internet (which contains multiple sessions in itself) on a mobile device, while downloading an email. With multiple sessions, all independent of each other, the difficulty in ascertaining the available bandwidth across all the sessions is increased. This traffic can be characterized as “bursty” in that in the aggregate of all sessions, the instantaneous bandwidth can far exceed or be well below the overall capacity of the wireless network.

The TCP protocol is ubiquitous and has to serve all types of network topologies, including wireless. It is thus highly desirable that any improvements in efficiency must be invisible and applicable to the existing servers that are the source of the TCP sessions, and the clients that are the recipients of the TCP sessions. It is also a requirement that any improvement have no effect on other network traffic and that full Quality of Service (QoS) be maintained.

The goal of increasing the efficiency of wireless networks can be solved by increasing the efficiency of retransmission, and solutions have been previously proposed.

For example, U.S. Pat. No. 7,489,691 introduced a method of scheduling for such data networks in a manner so as to decrease the retransmission delay. This comprises of providing the through packets with a flag indicating the retransmission status of said packet while also allocating a scheduling priority to such a packet. The scheduling priority is left to the implementer of this patent. Typically, retransmission packets would be allocated to the head of the transmission queue.

This invention does reduce the delay of retransmission packet receipt, however suffers when implemented within the ASM framework (an aggregate ACK). As delay times will vary depending on which packet was dropped, as the ACK for the packet will be within the aggregate ACK of a number of packets, the required solution will provide for the removal of unnecessarily retransmitted packets; a potential side effect of the above patent.

U.S. Pat. No. 7,334,175 introduces a solution that is likewise intended to alleviate the traffic on the network. Its solution operated under the assumption that if a corrupted packet (one that will require retransmission) has a transmission time interval of i then all other packets with the same transmission time interval are likewise corrupt. The transceiver then retransmits the group al all packets with the same transmission time interval.

This solution does decrease the number of negative acknowledgements sent back to the transceiver, however, as it works under the assumption that all packets sharing a transmission time interval are necessarily corrupt, it runs the risk of unnecessarily retransmitting packets.

### BRIEF SUMMARY

Techniques for retransmitting missing data packets are disclosed. For example, when a sender receives at least two reports of a missing data packet, and has no acknowledgements of receipt of the packet, then the packet is retransmitted. However, if a subsequent request is received for the same data packet, then retransmission will not occur until a timeout period has expired. The timeout period is the difference between the time of the subsequent request and the time of the first retransmission of the packet.

### BRIEF DESCRIPTION OF THE DRAWINGS

FIG. 1 is a block diagram illustrating the architecture and data flow of an Aggregated Session Management (ASM) system;

FIG. 2 is a block diagram showing the components of a cell module;

FIG. 3 is a flow diagram showing the process for acknowledging receipt of packets;

FIG. 4 is a timing diagram of the process shown in FIG. 3;

FIG. 5 is an example of a time-stamped report-request;

FIG. 6 is an example of a time-stamped report;

FIG. 7 is a flow diagram showing the process for determining whether to retransmit packets; and

FIG. 8 is a timing diagram of the process shown in FIG. 7.

### DETAILED DESCRIPTION

Systems and methods are described for retransmitting missing data packets. It should be appreciated that an embodiment can be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein. In the context of this document, a computer usable medium or computer readable medium may be any medium that can contain or store the program for use by or in connection with the instruction execution system, apparatus or device. For example, the computer readable storage medium or computer usable medium may be, but is not limited to, a random access memory (RAM), read-only memory (ROM), or a persistent store, such as a mass storage device, hard drives, CDROM, DVDROM, tape, erasable programmable read-only memory (EPROM or flash memory), or any magnetic, electromagnetic, infrared, optical, or electrical system, apparatus or device for storing information. Alternatively or additionally, the computer readable storage medium or computer usable medium may be any combination of these devices or even paper or another suitable medium upon which the program code is printed, as the program code can be electronically captured, via, for instance, optical scanning of the paper or other medium, then compiled, interpreted, or otherwise processed in a suitable manner, if necessary, and then stored in a computer memory.

Applications, software programs or computer readable instructions may be referred to as components or modules. Applications may be hardwired or hard coded in hardware or take the form of software executing on a general purpose computer such that when the software is loaded into and/or executed by the computer, the computer becomes an apparatus for practicing an embodiment. Applications may also be downloaded in whole or in part through the use of a software development kit or toolkit that enables the creation and implementation of an embodiment. In this specification, these implementations, or any other form that an embodiment may take, may be referred to as techniques. In general, the order of the steps of disclosed processes may be altered within the scope of this disclosure.

The disclosure of co-pending U.S. patent application Ser. No. 12/472,863, which is incorporated in full herein, includes discussion of an aggregated session management (“ASM”) system. A person having ordinary skill in the art will appreciate that the system that implements ASM as described in U.S. patent application Ser. No. 12/472,863 may also implement embodiments of this disclosure.

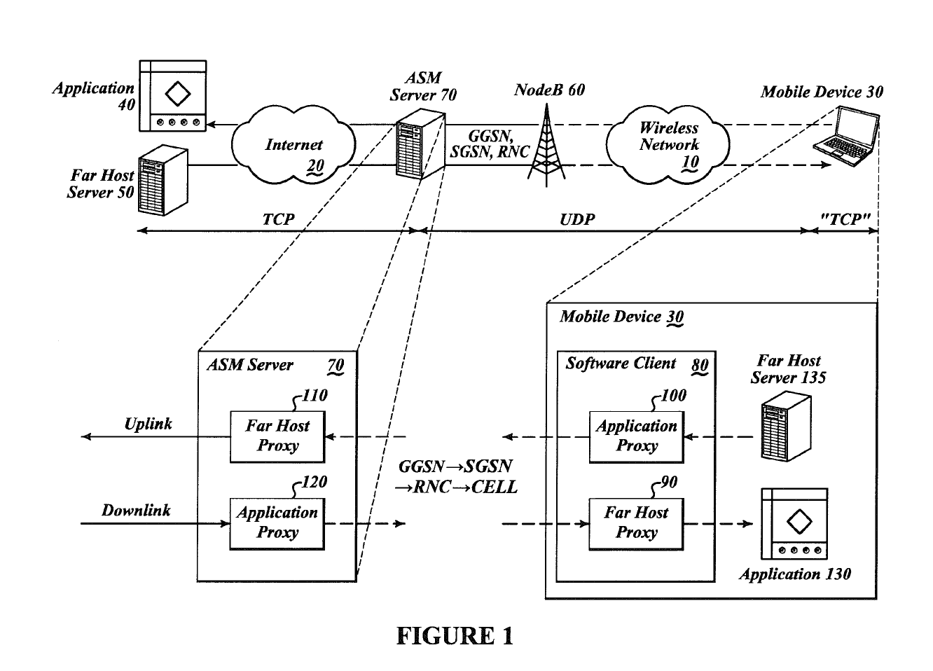

As shown in FIG. 1, mobile device 30 may access application 40, first through wireless network 10 which may be linked to Node B 60, and then through Gateway General Serving Support Node (“GGSN”), Serving GPRS Support Node (“SGSN”), or Radio Network Controller (“RNC”) to Proxy Server 70, which in turn may access application 40 through the Internet 20. In an embodiment described further below, the protocol used for packets transmitted between proxy server 70 and mobile device 30 may be UDP, while TCP may be used for packets transmitted between proxy server 70 and far host server 50. One of ordinary skill in the art will appreciate that even though proxy server 70 is shown as a single server computer, proxy server 70 may in fact comprise one or more computers. The elements shown in FIG. 1 are not intended to limit this disclosure in any way.

In an embodiment, ASM server 70 may be located at the point of initial traffic entry from the Internet to the mobile network. ASM server 70 may be one or several computers, with conventional components, including input and output means, a processor, and a memory. In a UMTS or GSM based network, this may be at the Gi interface of GGSN. Mobile device 30 may include software client 80, which may include far host proxy 90 and application proxy 100. ASM Server 70 may include its own far host proxy 110 and application proxy 120. In an embodiment, application proxies 100 and 120 may each terminate the TCP flows, extract the payload and encapsulate the payload into a UDP packet. In an embodiment, far host proxies 90 and 110 may each receive the UDP packet, extract the payload and present the payload to the application as a TCP packet.

Application proxy 120 within proxy server 70 may terminate TCP flows from far-host server 50 within the Internet 20. Within software client 80 on mobile device 30, application proxy 100 may terminate TCP flows from the application 130 running on mobile device 30. Mobile device 30 may act as far host server 135 in messages sent to application 40.

In an embodiment, far host proxy 110 within ASM server 70 may reverse the effects of application proxy 120 by converting packets to TCP. Within software client 80, however, the TCP packet may not be created, but the payload may be presented to application 130 as though it came from a TCP socket of the operating system operating on mobile device 30.

ASM server 70 may use application proxy 120 for downstream data flow (i.e. to mobile device 30) and may use far host proxy 110 for upstream data flow (i.e. to far host server 50). Software client 80 on mobile device 30 may use application proxy 100 for upstream data flow and far host proxy 90 for downstream data flow. Combined, the four proxies, 90, 100, 110 and 120 are referred to herein as the Dynamic Multimedia Proxy (“DMP”). In this fashion, the DMP allows for flow control specifically designed for wireless networks, while “hiding” the behavior of the wireless network from the original TCP far host and TCP client flow control mechanisms.

Network system 100 of FIG. 1 can be used to support a system for facilitating client assisted stateful handling data communications within the network. For this implementation, server 70, which is located at the point of initial traffic entry from the Internet to the mobile network, functions as an ASM server. In a UMTS or GSM based network, this server is located at the GI interface of GGSN. In addition, a software client module 80 is loaded onto the mobile device 30. Both of the components contain two proxy functions that act similarly, that is, as an application proxy and a far host proxy. The application proxy terminates the TCP flows, extracts the payload and encapsulates it into a UDP packet. The far host proxy receives the UDP packet, extracts the payload and presents it to the application as a TCP packet. The application proxy within the server terminates TCP flows from far-host servers sitting somewhere on the Internet. Within the mobile device client 30, the application proxy 120 terminates TCP flows from the applications that are running on the client itself. The far host proxy 110 within the server 70 essentially reverses the effects of the application proxy 120 by converting the packet to TCP. Within the software client 80 however, the TCP packet is not created but the payload is presented to the application as though it came from a TCP socket of the operating system.

The server 70 acts as an application proxy for downstream data flow (i.e. towards the mobile client 30) and the far host proxy for upstream data flow. The software client 80 acts as the application proxy for upstream data flow and the far host proxy for downstream data flow. Combined, the four proxies make up the dynamic multimedia proxy (DMP).

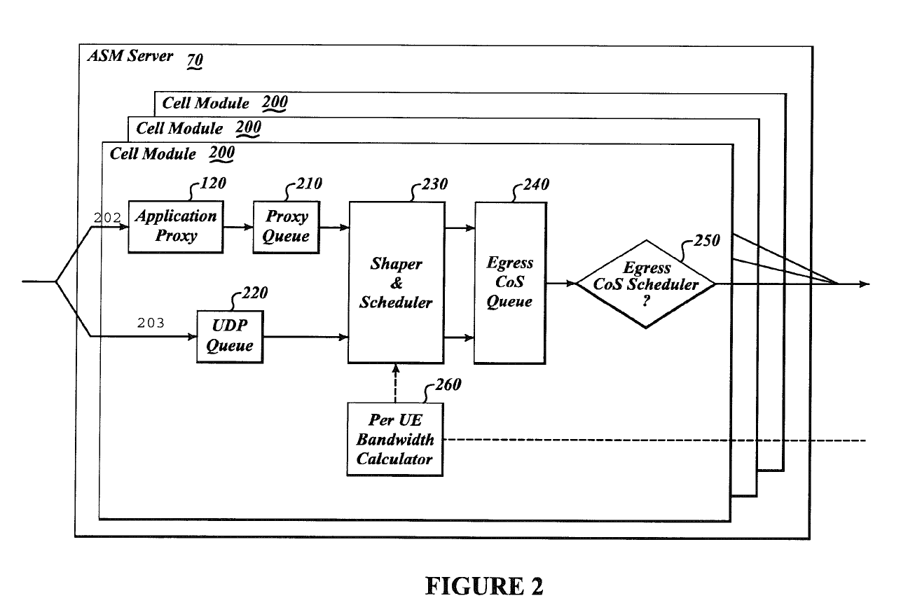

Application proxy 120 on ASM server 70 has several additional components to provide efficient packet flow. Since there are typically multiple cells operating within wireless network 10, each cell manages its own data flow. Therefore, within ASM server 70, multiple cell modules 200 are present, as shown in FIG. 2. Each cell within wireless network 10 is assigned a unique cell module 200 for monitoring traffic.

In one embodiment, each cell module 200 includes the following components:

Application Proxy 120:

Application proxy 120 appears to far host server 50 as an application. Application proxy 120 terminates the TCP protocol, and provides far host server 120 the required handshakes.

Proxy Queue 210:

Proxy queue 210 stores the payloads for a particular TCP session. The output of proxy queue 210 is a TCP payload encapsulated in a UDP packet.

UDP Queue 220:

UDP queue 220 stores the UDP sessions.

Shaper and Scheduler 230:

Shaper and scheduler 230 schedules for transmission the UDP payloads stored in both proxy queue 210 and UDP queue 220 and enqueues the packets to egress Class of Service (CoS) queue 240. Furthermore, shaper and scheduler 230 provides both appropriate fairness for the subscribers to a cell, and appropriate fairness for all active sessions on a client.

Egress CoS Queue 240:

Each cell in wireless network 10, and each cell module 200 has one or more egress CoS queues 240. For example, for UMTS, there are typically 3 cells per Node B antenna. All packets destined for the particular Node B antenna of the cell corresponding to the cell module 200 is placed in egress CoS queue 240.

Egress CoS Scheduler 250:

Egress CoS scheduler 250 uses an algorithm based on typical QoS requirements to select which egress CoS queue 240 to use to extract the next packet to be transmitted.

Per Mobile Device Bandwidth Calculator 260:

Per mobile device bandwidth calculator 260 calculates an optimal bandwidth based on both the bandwidth available on wireless network 10 and the bandwidth available to mobile device 30.

Each module described above may be implemented in hardware or software within ASM server 70 using well known methods.

As seen in FIG. 2, two streams of packets flow through cell module 200, a first stream 202 handling incoming TCP packets, and a second stream 203 handling incoming UDP packets.

Scheduler and shaper 230 therefore performs two functions. The first function is scheduling the delivery of packets into egress CoS queue 240 by fairly selecting a mobile device 30 and then fairly selecting a packet from one of that particular user's session queues. In addition to scheduling, scheduler and shaper 230 shapes the flow of data by using the incoming bandwidth information provided by per mobile device bandwidth calculator 260 about the aggregate bandwidth of all streams terminating at the particular mobile device 30, to determine the optimal flow speed of the mobile device.

Another functioned performed by ASM server 70 is to number the outgoing packets. Thus, when receiving a report from a receiver, as described below, ASM server 70 will be able to determine which packets were not received. If the last packet sent was not received, the report will not include an acknowledgement of that packet, so that ASM server 70 will be able to determine if that packet was not received.

ASM and Acknowledgement

To significantly decrease the number of Acknowledgement (ACK) packets transmitted through wireless network 10, the receiver (i.e. the mobile device 30, far host server 50, or ASM server 70 receiving the packets, as appropriate) sends a single reply containing a consolidated report of all of the current sessions with the sender. The receiver however, only transmits such a packet to the sender after the sender (i.e. the mobile device 30, far host server 50, or ASM server 70 sending the packets, as appropriate) has sent a report-request to the receiver. The sender dispatches report-requests at a pre-determined frequency t that both minimizes the time it takes for retransmission of any arbitrary lost packet, and minimizes the amount of traffic on wireless network 10. To provoke the receiver to send such a report, the sender sends a report-request to the receiver with a timestamp. On receipt of the report-request, the receiver replies with a report containing: the timestamp in the report-request; an ACK for the last packet received from the sender; a report of all the missing packets for all sessions from the sender; and a report containing the rate of receipt (i.e. bandwidth) since the last report-request from the sender.

If there is no data to retransmit, i.e., the report did not indicate packets were not received, then the sender increases time interval t so that no more than one report-request is sent per second. If there is no more data to either send or retransmit since the last report-request and all sent data has been acknowledged, following three acknowledgements of the last packet sent, the sender may cease sending report-requests.

The report includes the last packet received from the sender, so that if last packet sent is not the expected packet (e.g., packet number 9 of 10 is acknowledged three times, but not packet 10, then the sender knows packet 10 was not received).

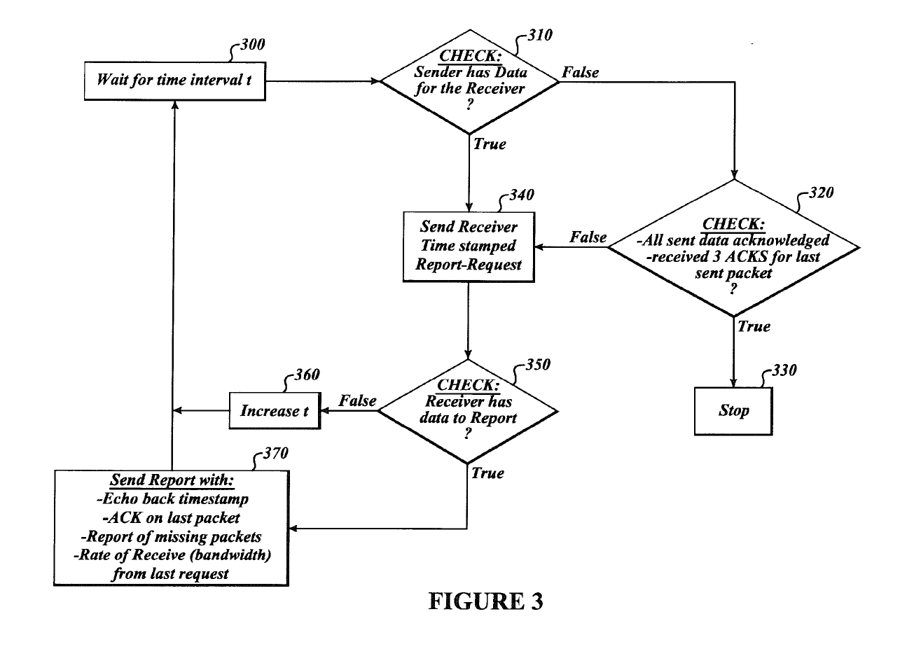

FIG. 3 illustrates a method by which a request and report-request are transmitted. In step 300, the system waits until time t has passed. Then, the sender determines if it has new packets to send to the receiver (step 310). If there is no data for the receiver, the system then checks to see if all sent data has been acknowledged and three ACKs have been received for the last packet sent to receiver (step 320). If so, the process ends (step 330). If not, the sender sends a time stamped report-request to the receiver at step 340, which is also done if the sender has data for the receiver at step 310.

On receiving the report-request, the receiver determines if it has data to report (step 350). If not, the sender increases time interval t (step 360) and the sender waits for the new t to pass (step 300). If there is data to report, receiver sends a report to sender, including an ACK for the last packet received, the time stamp of the report-request, a report of missing packets and the rate of receipt of packets (step 370).

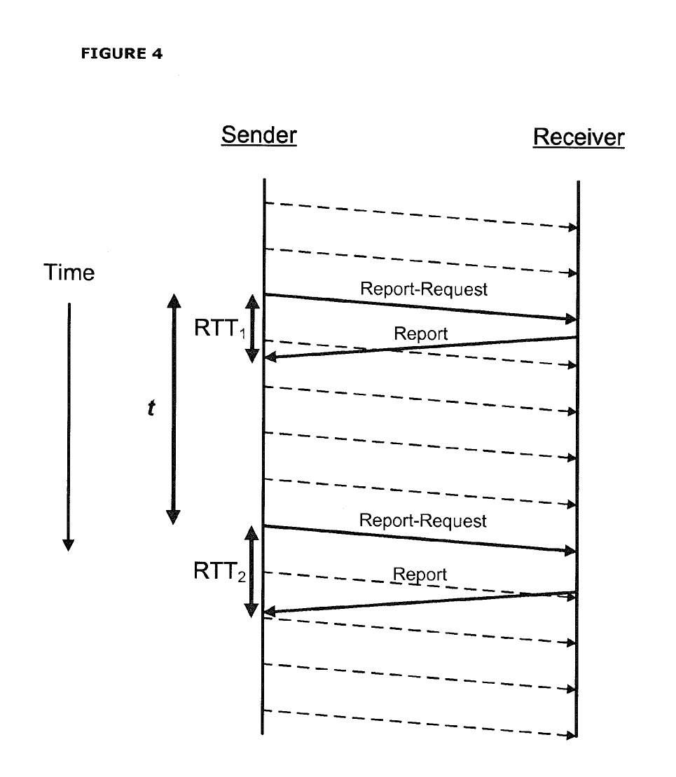

FIG. 4 provides the reader with a time diagram of the report-request process. RTT (Round Trip Time) represents the time taken between the sending of a report-request and the receipt of the report.

Use Example

An example illustrating the invention includes a mobile device 30, such as a 3G Smartphone (acting as the receiver) browsing the Internet 20 with multiple windows open, thus creating multiple sessions. The packets provided to mobile device 30 pass through a gateway, such as a Network Access Translator (NAT), that authorizes connection to the Internet 20. As the packets travel through the gateway, without loss of generality, it assumes the role of the sender and acts as ASM server 70.

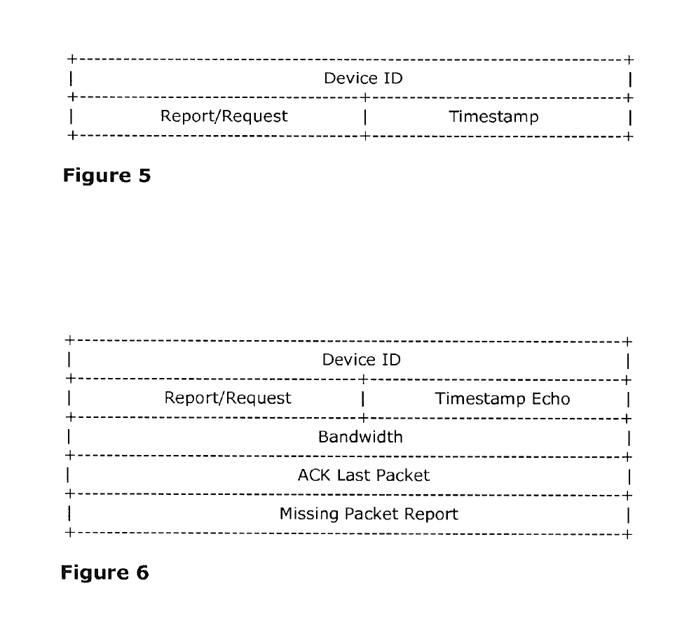

The gateway tracks the sent data packets from each of the established sessions of mobile device 30. To determine the success of each transferred packet, the gateway sends time-stamped report-request packet, as seen in FIG. 5, to mobile device 30 at a predetermined time interval t.

On receipt of the report-request, mobile phone 30 lists the packets that have not been received and sends a report, as seen in FIG. 6, to the sender. The sender enumerates all the incoming packets so the receiver easily discerns which packets were not received.

The Report/Request field within both the report-request and the report packets is a one-bit field that indicates whether the message is a request (1) or a response (0).

If the sender has data to transmit but the receiver has nothing to report, the time interval t is increased via some mechanism, such as increasing t by a fixed time, or multiplying t by a fixed amount, to both maintain service levels and take advantage of available bandwidth.

Once the user of mobile device 30 has finished browsing the Internet, the sessions associated with mobile device 30 become dormant. Once the sender has received three ACKs, embedded within three reports, on the same last packet sent, all sessions are concluded and the report-request process is likewise terminated.

The transmission of report-request packets is time based so that if no report is received in the time interval t, due to either a lost report-request or a lost report, the sender transmits another report-request following the expiration of t as per usual.

The disclosure of co-pending U.S. patent application Ser. No. 12/472,863 is incorporated in full herein, and includes discussion of an ASM system.

Retransmission

In an ASM network, all data packets intended for the mobile device 30 are treated as one collective stream, and not as individual sessions. This suggests that the report-request scheme described above would provide for an efficient method of retransmission in an ASM network.

In one embodiment, retransmission of lost packets takes precedence over transmission of new data. The timestamp method described above is used to calculate an accurate RTT in order to avoid premature retransmissions.

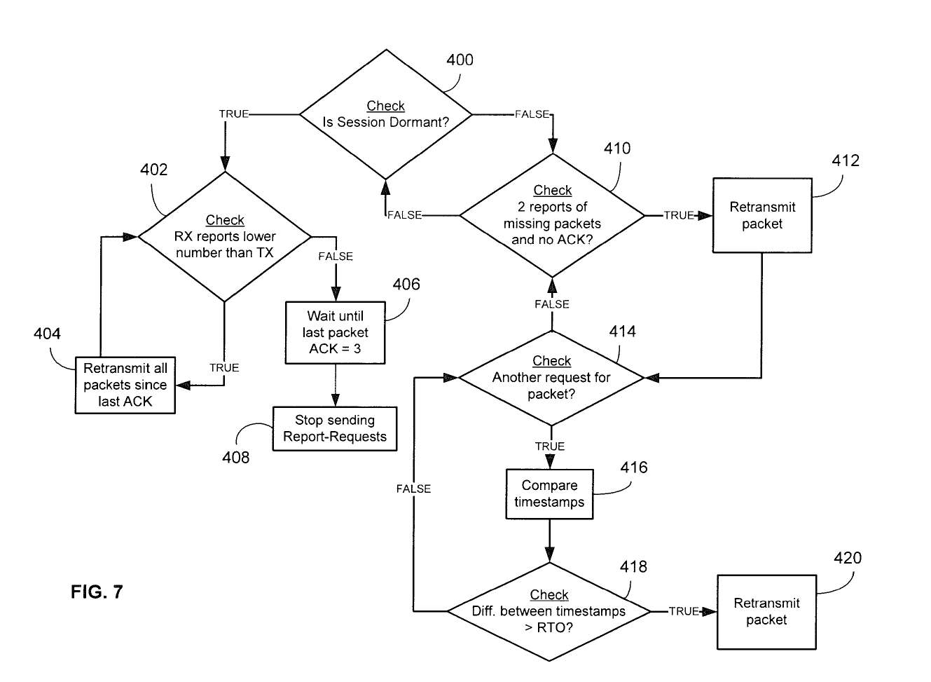

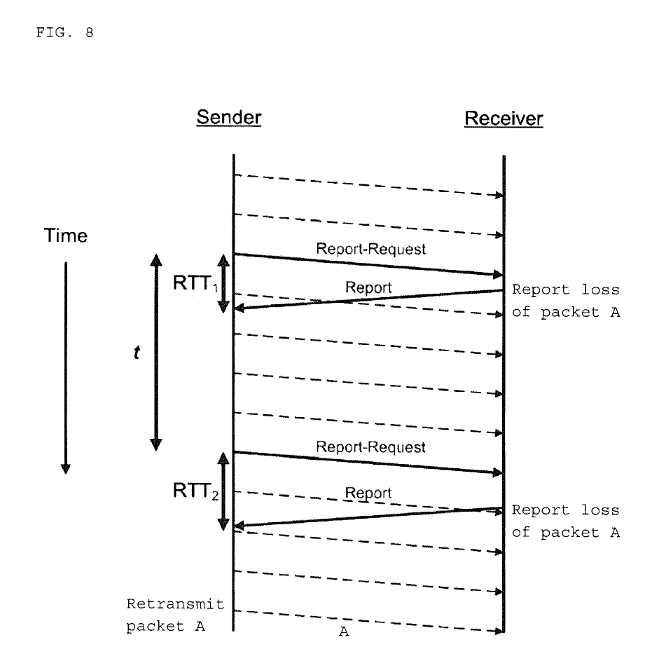

FIG. 7 illustrates one embodiment of a method for retransmission of lost packets. In step 400, the status of the sender session is checked. If it is dormant, then the sender has no data to send or retransmit. However, while the sender is dormant, if the receiver has acknowledged a lower sequence number in its report than the sender had transmitted (step 402), then all packets since the last acknowledged packet are resent in step 404. If all data has been acknowledged in step 402, then after receiving three ACKs for the last packet sent (step 406), the sender may stop sending report-requests (step 408).

If the sender is not dormant (step 400), then after receiving two reports that indicate that the packet is missing, and having no ACK for the packet (step 410), it will retransmit the packet (step 412).

If a subsequent request for retransmission of the same packet is received (step 414), then the timestamp of the subsequent request is compared to the timestamp of the transmitted packet (step 416). If the difference is greater than the calculated Retransmission Timeout (RTO) in step 418, then the packet is retransmitted in step 420. Otherwise, the packet remains in the retransmission queue.

FIG. 8 shows the timing diagram for the retransmission process, similar to FIG. 4, except that the initial report indicates the loss of packet A, and after a second report of that loss, the send retransmits the packet.

The calculation of RTT and RTO will now be described.

The calculation of RTT is a continuous process that relies on the previously calculated RTT. In one embodiment, a Smooth RTT (SRTT) is employed recursively, as follows:

SRTT(i)=(1−aα)×SRTT(i−1)+RTT(i)

where α=⅛ as a smoothing factor; RTT(i) is the ith timestamp calculated RTT; SRTT(i−1) is the (i−1)th calculated SRTT; and SRTT(1) is assigned the value RTT(1) as the base for the recursion.

The calculation of RTO relies upon the calculation of SRTT, as follows:

RTO(i)=β×SRTT(i)

where β=2 (recommended value); and SRTT(i) is the ith calculated SRTT.

As will be apparent to those skilled in the art, the various embodiments described above can be combined to provide further embodiments. Aspects of the present systems, methods and components can be modified, if necessary, to employ systems, methods, components and concepts to provide yet further embodiments of the invention. For example, the various methods described above may omit some acts, include other acts, or execute acts in a different order than set out in the illustrated embodiments.

The present methods, systems and articles also may be implemented as a computer program product that comprises a computer program mechanism embedded in a computer readable storage medium. For instance, the computer program product could contain program modules for installing and operating the applications described above. These program modules may be stored on CD-ROM, DVD, magnetic disk storage product, flash media or any other computer readable data or program storage product. The software modules in the computer program product may also be distributed electronically, via the Internet or otherwise, by transmission of a data signal (in which the software modules are embedded) such as embodied in a carrier wave.

For instance, the foregoing detailed description has set forth various embodiments of the devices and applications via the use of examples. Insofar as such examples contain one or more functions or operations, it will be understood by those skilled in the art that each function or operation within such examples can be implemented, individually and/or collectively, by a wide range of hardware, software, firmware, or virtually any combination thereof. In one embodiment, the present subject matter may be implemented via Application-Specific Integrated Circuits (ASICs). However, those skilled in the art will recognize that the embodiments disclosed herein, in whole or in part, can be equivalently implemented in standard integrated circuits, as one or more computer programs running on one or more computers, as one or more programs running on one or more controllers (e.g., microcontrollers) as one or more programs running on one or more processors (e.g., microprocessors), as firmware, or as virtually any combination thereof, and that designing the circuitry or writing the code for the software and or firmware would be well within the skill of one of ordinary skill in the art in light of this disclosure.

In addition, those skilled in the art will appreciate that the applications taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, flash drives and computer memory; and transmission type media such as digital and analog communication links using TDM or IP based communication links (e.g., packet links).

These and other changes can be made to the present systems, methods and applications in light of the above description. In general, in the following claims, the terms used should not be construed to limit the invention to the specific embodiments disclosed in the specification and the claims, but should be construed to include all possible embodiments along with the full scope of equivalents to which such claims are entitled. Accordingly, the invention is not limited by the disclosure, but instead its scope is to be determined entirely by the following claims.

1. A method for retransmitting data packets in a wireless network, comprising:
receiving at least two reports of a first packet missing;
retransmitting the first packet;
receiving a subsequent request for the first packet;
obtaining a time difference between a first timestamp of the subsequent request and a second timestamp of the retransmission of the first packet;
if the time difference is greater than a predefined retransmission timeout, then again retransmitting the first packet.

2. The method of claim 1, wherein the predefined retransmission timeout is defined as β×SRTT(i), wherein SRTT(i) is defined recursively as (1−α)×SRTT(i−1)+RTT(i).

3. The method of claim 2, wherein α=⅛ and β=2.

4. A computer readable storage medium having instructions for retransmitting data packets in a wireless network, comprising:
receiving at least two reports of a first packet missing;
retransmitting the first packet;
receiving a subsequent request for the first packet;
obtaining a time difference between a first timestamp of the subsequent request and a second timestamp of the retransmission of the first packet;
if the time difference is greater than a predefined retransmission timeout, then again retransmitting the first packet.
